(19) United States
(12) Patent Application Publication
(10) Pub. No.: US 2016/0105813 A1
(43) Pub. Date: Apr. 14, 2016

(54) METHOD FOR CELL SELECTION IN A HETEROGENEOUS NETWORK BY USER EQUIPMENT IN A CRE REGION

(71) Applicant: Samsung Electronics Co., Ltd., Gyeonggi-do (KR)

(72) Inventors: Balaji Srinivasan THIRUVENKATACHARI, Bangalore (IN); Shrinath Ramamoorthy Madhurantakam, Bangalore (IN)

(73) Assignee: Samsung Electronics Co., Ltd.

(21) Appl. No.: 14/860,041

(22) Filed: Sep. 21, 2015

(30) Foreign Application Priority Data
Oct. 8, 2014 (IN) 5052/CHE/2014

(51) Int. Cl. H04W 24/08; H04W 4/06; H04W 36/04; H04W 72/04; H04W 72/08

(52) U.S. Cl. CPC H04W 24/08; H04W 72/0453; H04W 72/085; H04W 36/04; H04W 4/06

(57) ABSTRACT

A method and system are provided for a User Equipment (UE) to perform cell selection in a Cell Range Extension (CRE) region in a heterogeneous network. The method includes avoiding barring a primary frequency at a transition to an idle mode, after failing to acquire System Information (SI) from a pico cell in the heterogeneous network; and camping on a cell corresponding to one of the primary frequency and a secondary frequency.

### PRIORITY

This application claims priority under 35 U.S.C. §119(a) to Indian Patent Application No. 5052/CHE/2014, which was filed in the Indian Patent Office on Oct. 8, 2014, the content of which is incorporated herein by reference.

### BACKGROUND

1. Field of the Disclosure

The embodiments herein relate generally to cell selection in a heterogeneous network, and more particularly, to methods and systems for cell selection by a User Equipment (UE) in a Cell Range Expansion (CRE) region.

2. Description of the Related Art

A heterogeneous network includes a combination of high power macro cells and low power pico cells in a geographical area. The pico cells are deployed to offload UEs from the macro cells, thereby increasing system capacity. Generally, a pico cell has a smaller coverage than a macro cell and may overlap with the macro cell. Also, the pico cell operates in the same or a different frequency from the macro cell, and uses a low transmit power compared to the macro cell.

The 3^{rd} Generation Partnership Project (3GPP) has introduced a cell coverage extension known as Cell Range Extension (CRE) in the heterogeneous network, where the coverage extension of the pico cell is adjusted to realize the cell coverage extension of the pico cell in the macro cell. The macro cell offloads a UE to reduce the load of the macro cell in order to improve the spectrum efficiency and to increase network capacity.

The 3GPP also introduced inter-cell interference coordination, known as enhancement of the Inter-Cell Interference Coordination (eICIC), in which an interference coordination mechanism is almost an empty child frame (Almost Blank Subframe (ABS)), designed to solve the interference problem from mixing channel deployment of base stations.

In a conventional system, when there is no data exchange between the UE in the CRE region and the pico cell, a Radio Resource Control (RRC) connection is released by the pico cell, and the UE enters into an idle mode and starts performing a cell selection procedure. After entering into the idle mode, the UE attempts to acquire System Information (SI) from a last connected cell (e.g., a pico cell). However, the UE may fail to acquire the SI due to interference caused by the macro cell or due to poor network conditions (e.g., where the signal strength of the pico cell is weaker in the CRE region).

In the conventional system, when the UE fails to acquire the SI from the pico cell, then the UE bars the frequency of the pico cell for a duration of 300 seconds. Thus, the UE cannot scan the frequency of the pico cell and may not obtain the services of the pico cell for the duration of 300 seconds.

Further, the UE camps on the macro cell for obtaining the services in the CRE region. However, if all the UEs in the CRE region camp onto the macro cell, offloading the UEs to the pico cell requires additional measurements and signaling messages.

### SUMMARY

An aspect of the embodiments herein is to provide a method and system for a cell selection by a UE in a CRE Region.

Another aspect of the embodiments herein is to provide a method and system for removing a barred frequency by the UE in the CRE region.

Another aspect of the embodiments herein is to provide a method and system for removing the barred frequency in an idle mode by the UE in the CRE region.

In accordance with an aspect of the embodiments herein, a method is provided for cell selection in a heterogeneous network by a UE in a CRE region. The method includes avoiding barring a primary frequency at a transition to an idle mode, after failing to acquire System Information (SI) from a pico cell in the heterogeneous network; and camping on a cell corresponding to one of the primary frequency and a secondary frequency.

In accordance with another aspect of the embodiments herein, a method is provided for removing a barred frequency by a UE in a CRE region. The method includes barring a frequency at a transition to an idle mode, after failing to acquire System Information (SI) from a pico cell in the heterogeneous network; receiving, from a macro cell, a control message that requests the UE to report measurements associated with the pico cell; and removing the frequency from a barred list, in response to the control message.

In accordance with another aspect of the embodiments herein, a UE is provided for cell selection in a CRE region in a heterogeneous network. The UE includes an integrated circuit including a processor; and a memory that stores a computer program code. The computer program code, when executed by the processor, controls the UE to: avoid barring a primary frequency at a transition to an idle mode, after failing to acquire System Information (SI) from a pico cell in the heterogeneous network; and camp on a cell corresponding to one of the primary frequency and a secondary frequency.

These and other aspects of the embodiments described herein will be better appreciated and understood when considered in conjunction with the following description and the accompanying drawings. It should be understood, however, that the following descriptions, while indicating certain embodiments and numerous specific details thereof, are given by way of illustration and not of limitation. Many changes and modifications may be made within the scope of these embodiments without departing from the spirit thereof, and the embodiments herein include all such modifications.

### BRIEF DESCRIPTION OF THE DRAWINGS

The above and other aspects, features, and advantages of certain embodiments herein will be more apparent from the following detailed description taken in conjunction with the accompanying drawings in which:

FIG. 1A illustrates a heterogeneous network including various types of cells operating in a same frequency, where a UE in a CRE region performs cell selection, according to an embodiment as disclosed herein;

FIG. 1B illustrates a heterogeneous network including various types of cells operating in different frequencies, where a UE performs cell selection in a CRE region, according to an embodiment as disclosed herein;

FIG. 2 illustrates a UE for cell selection in a CRE region in a heterogeneous network, according to an embodiment as disclosed herein;

FIG. 3 is a flow diagram illustrating a method of cell selection by a UE in a CRE region in a heterogeneous network, according to an embodiment as disclosed herein;

FIG. 4 is a flow diagram illustrating a method for removing a barred frequency, after barring a frequency of a pico cell, according to an embodiment as disclosed herein;

FIG. 5 is a flow diagram illustrating a method for removing a barred frequency in an idle mode, after barring a frequency of the pico cell, according to an embodiment as disclosed herein;

FIG. 6 is a sequence diagram illustrating various signaling flow messages between a macro cell and a UE in a CRE region for removing a barred frequency, according to an embodiment as disclosed herein; and

FIG. 7 is a sequence diagram illustrating various signaling messages between a macro cell and a UE in a CRE region for removing a barred frequency in an idle mode, according to an embodiment as disclosed herein.

Although specific features of the present invention are shown in some drawings and not in others, this is done for convenience only as each feature may be combined with any or all of the other features in accordance with the present invention.

### DETAILED DESCRIPTION OF THE EMBODIMENTS OF THE DISCLOSURE

In the following detailed description, reference is made to the accompanying drawings that form a part hereof, and in which are shown by way of illustration specific embodiments that may be practiced. These embodiments are described in sufficient detail to enable those skilled in the art to practice the invention, and it is to be understood that other embodiments may be utilized and that changes may be made without departing from the scope as recited in the appended claims. The following detailed description is, therefore, not to be taken in a limiting sense, and the scope of the embodiments is defined only by the appended claims.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It may be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It may be further understood that terms, such as those defined in commonly used dictionaries, should be interpreted as having a meaning that is consistent with their meaning in the context of the relevant art and may not be interpreted in an idealized or overly formal sense unless expressly so defined herein.

The embodiments herein achieve a method and system for cell selection by a UE in a CRE region in a heterogeneous network. The method includes avoiding barring of a primary frequency on transition to an idle mode, when acquiring SI from a pico cell by the UE has failed. Further, the method includes camping on a cell corresponding to either the primary frequency or a secondary frequency.

Unlike the conventional system, the present method avoids barring of the frequency of the pico cell on transition to the idle mode in the CRE region. This facilitates the UE to select or reselect the pico cell, when the UE enters the radio coverage of the pico cell, and the UE can avail one or more services provided by the pico cell. The present method and system of avoiding barring of the frequency of the pico cell facilitates load balancing, because the UE can select the pico cell rather than being camped on the macro cell.

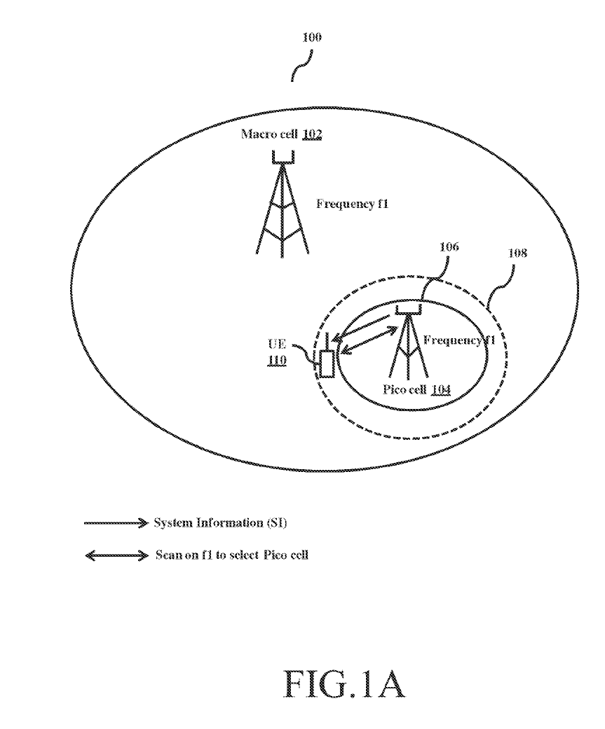

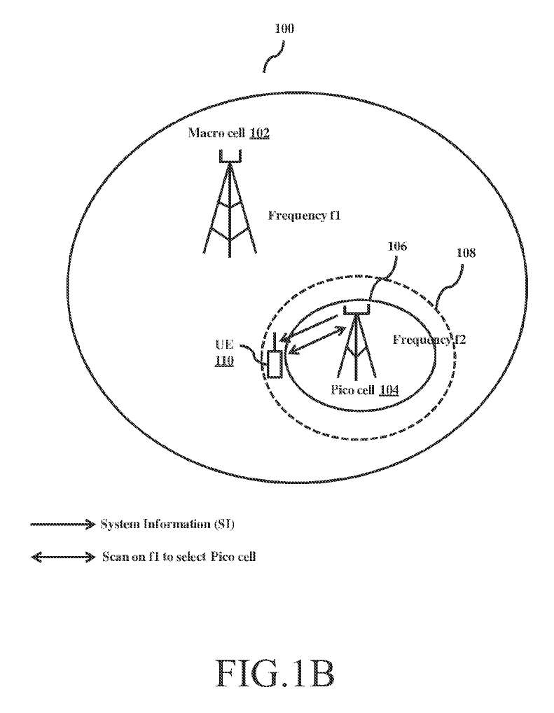

FIG. 1A illustrates a heterogeneous network including various types of cells operating in a same frequency, where a UE in a CRE region performs cell selection, according to an embodiment as disclosed herein.

Referring to FIG. 1A, a heterogeneous network 100 includes a macro cell 102, a pico cell 104, and a UE 110. The macro cell 102 and the pico cell 104 are operating in the same frequency f1. Reference number 106 refers to a radio coverage area of the pico cell 104 and the reference number 108 refers to an enlarged area of the pico cell 104, which is referred to herein as the CRE region. In the CRE region 108, the UE 110 is served by the pico cell 104. Because the CRE is an extension of the coverage of the pico cell 104, the signal strength of the pico cell 104 is often low therein.

In the CRE region 108, the UE 110 obtains one or more services of the pico cell 104. When there is no data exchange between the UE 110 and the pico cell 104, then the pico cell 104 releases the RRC connection with the UE 110. The UE 110 returns to the idle mode and performs cell selection procedure.

During the cell selection procedure, the UE 110 attempts to camp on a last connected cell (which is the pico cell 104). Further, the UE 110 monitors the SI from the pico cell 104 and attempts to acquire the SI from the pico cell 104. The SI includes, but is not limited to, a Master Information Block (MIB), a System Information Block 1 (SIB 1), and a System Information Block 2 (SIB 2).

When the UE 110 fails to acquire the SI from the pico cell 104, the UE 110 avoids barring of the frequency f1 of the pico cell 104. Specifically, the UE 110 receives, from the pico cell, a control message including an Information Element (IE) that indicates that the UE is to avoid barring of the frequency f1. Further, the UE 110 scans on the frequency f1 to camp on the macro cell 102. Thereafter, the UE 110 acquires the SI from the macro cell 102 and camps on the macro cell 102.

In certain situations, based on the load conditions in the macro cell 102, the macro cell 102 may request the UE 110 to measure the pico cell 104 for offloading the UE 110 to the pico cell 104. Specifically, the UE 110 receives a measurement report request from the macro cell 102 and measures the pico cell 104 in response to the request. Thereafter, the UE 110 sends the measurement report to the macro cell 102 and the macro cell 102 determines whether to offload the UE 110 to the pico cell 104, based on the measurement report obtained from the UE 110.

FIG. 1B illustrates a heterogeneous network including various types of cells operating in different frequencies, where a UE in a CRE region performs cell selection, according to an embodiment as disclosed herein.

Referring to FIG. 1B, the heterogeneous network 100 includes the macro cell 102, the pico cell 104, and the UE 110. The macro cell 102 is operated in frequency f1, and pico cell 104 is operated in frequency f2. Although FIG. 1B illustrates the macro cell 102 and the pico cell 104 operating in the frequency f1 and the frequency f2, respectively, it can be understood to a person of ordinary skill in the art that the operating frequencies f1 and f2 of the macro cell 102 and the pico cell 104 can be interchangeable.

When the UE 110 is in the CRE region 108, the UE 110 obtains one or more services of the pico cell 104. When the UE 110 is in the CRE region, and if there is no data exchange between the UE 110 and the pico cell 104, then the pico cell 104 releases the RRC connection with the UE 110. The UE 110 returns to an idle mode and performs cell selection procedure.

During the cell selection procedure, the UE 110 attempts to camp on the last connected cell (which is the pico cell 104). Further, the UE 110 monitors the SI from the pico cell 104 on the frequency f2 in an attempt to acquire the SI from the pico cell 104, during the cell selection procedure.

When the UE 110 fails to acquire the SI from the pico cell 104, the UE 110 avoids barring of the frequency 12 of the pico cell 104. Specifically, the UE 110 receives, from the pico cell 104, a control message including an IE that indicates the UE is to avoid barring the frequency f2. Thereafter, the UE 110 scans the frequency 12 to camp on the macro cell 102. Further, the UE 110 acquires the SI from the macro cell 102 and camps on the macro cell 102.

After camping on the macro cell 102, the UE 110 may enter into the radio coverage area 106 of the pico cell 104 and scan the frequency 12 of the pico cell 104 to camp on the pico cell 104. Further, the UE 110 camps on the pico cell 104 for obtaining one or more services from the pico cell 104.

In certain situations, based on the load conditions in the macro cell 102, the macro cell 102 may request the UE 110 to measure the pico cell 104 for offloading the UE 110 to the pico cell 104. Specifically, the UE 110 receives a measurement report request from the macro cell 102 and measures the pico cell 104 in response to the request. The UE 110 sends the measurement report to the macro cell 102, which determines whether to offload the UE 110 to the pico cell 104, based on the measurement report obtained from the UE 110.

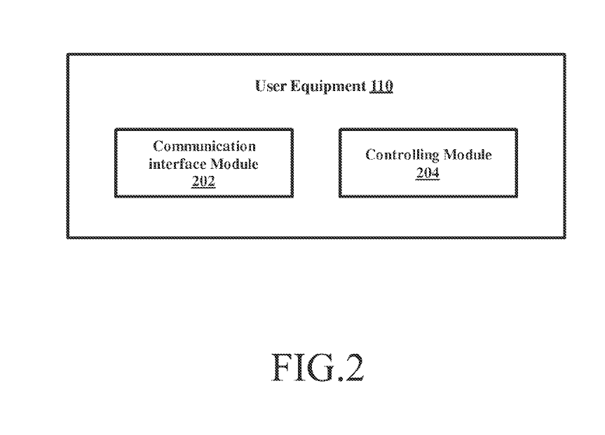

FIG. 2 illustrates a UE for cell selection in a CRE region in a heterogeneous network, according to an embodiment as disclosed herein.

Referring to FIG. 2, the UE 110 comprises a communication interface module 202, and a controlling module 204. The communication interface module 202 connects the UE 110 to the heterogeneous network 100. For example, the communication interface module 202 camps the UE 110 on the macro cell 102 or the pico cell 104 in the heterogeneous network 100.

The controlling module 204 performs one or more actions for facilitating cell selection, when the UE 110 is in the heterogeneous network 100. Specifically, the controlling module 204 scans a frequency of the macro cell 102 or the pico cell 104 during the cell selection by the UE 110.

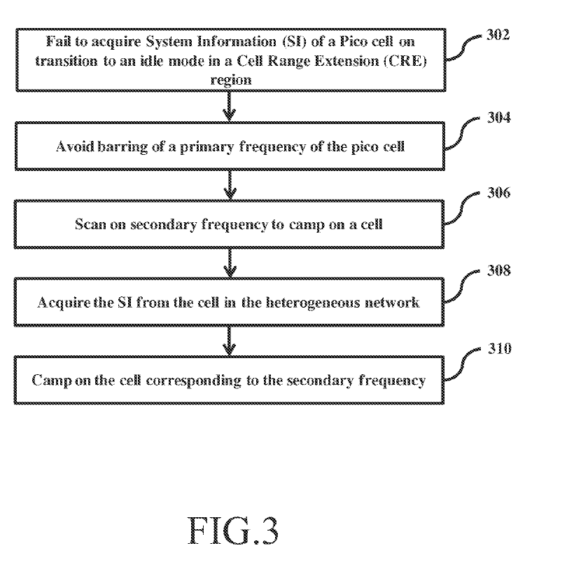

FIG. 3 is a flow diagram illustrating a method for cell selection by a UE in a CRE region network in a heterogeneous, according to an embodiment as disclosed herein.

Referring to FIG. 3, in step 302, the UE in the CRE region fails to acquire SI of a pico cell on transition to an idle mode. For example, as illustrated in FIG. 2, the controlling module 204 of the UE 110 may fail to acquire the SI from the pico cell 104 due to weak signal strength of the pico cell 104 in the CRE region or due to interference from the macro cell 102 (when the macro cell 102 and the pico cell 104 are operating on the same frequency).

In step 304, the UE avoids barring of a primary frequency (frequency f1) of the pico cell 104. For example, as illustrated in FIG. 2, the controlling module 204 avoids barring of the primary frequency f1 of the pico cell 104, after the UE 110 receives a control message including an IE that indicates that the UE 110 is to avoid barring of the primary frequency corresponding to the pico cell 104.

In step 306, the UE scanning a secondary frequency (frequency f2) to camp on a cell. For example, as illustrated in FIG. 2, the controlling module 204 scans the secondary frequency to camp on the cell. The secondary frequency may correspond to the macro cell 102, pico cell 104, or any neighboring pico cell.

In step 308, the UE acquires the SI from the cell in the heterogeneous network. For example, as illustrated in FIG. 2, the controlling module 204 acquires the SI from the macro cell 102 or from any of neighboring the pico cell operating in the secondary frequency f2 in the heterogeneous network.

In step 310, the UE camps on the cell corresponding to the secondary frequency. For example, as illustrated in FIG. 2, the UE 110 camps on the cell (e.g., the macro cell 102, pico cell 104, or any of the neighboring pico cell in the heterogeneous network) corresponding to the secondary frequency C.

Some of the various actions, units, steps, blocks, or acts illustrated in FIG. 3 may be performed in the order presented, in a different order, simultaneously, or a combination thereof. Furthermore, in some embodiments, some of the actions, units, steps, blocks, or acts illustrated in FIG. 3 may be omitted.

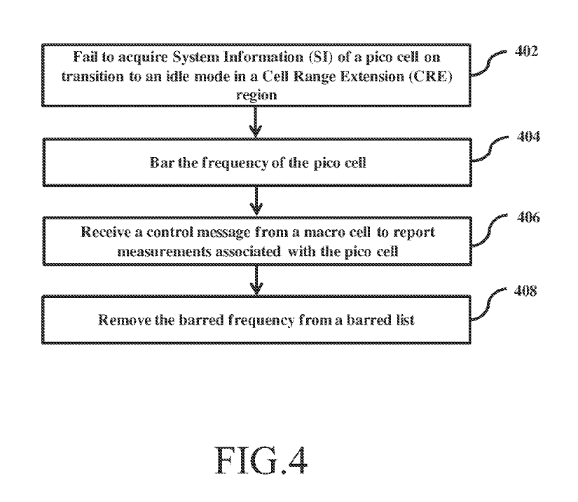

FIG. 4 is a flow diagram illustrating a method for removing a barred frequency after barring a frequency of a pico cell, according to an embodiment as disclosed herein.

Referring to FIG. 4, in step 402, the UE in a CRE region fails to acquire SI of a pico cell on transition to an idle mode. For example, as illustrated in FIG. 2, the controlling module 204 in the UE 110 in the CRE region fails to acquire the SI from the pico cell 104 due to weak signal strength of the pico cell 104 or due to the interference from the macro cell 102 (when the macro cell 102 and the pico cell 104 are operating on the same frequency).

In step 404, the UE bars the frequency of the pico cell. For example, as illustrated in FIG. 2, the controlling module 204 bars the frequency of the pico cell. That is, the controlling module 204 bars the frequency (for example f1) of the pico cell 104 for the cell selection. When the frequency of the pico cell 104 is barred for cell selection, the controlling module 204 scans the secondary frequency f2. Thereafter, the UE 110 sends the RRC connection request to the macro cell 102 and enters into connected mode. Further, the UE 110 acquires the SI from the macro cell 102 and camps on the macro cell 102 on the secondary frequency f2 during the cell selection procedure.

In step 406, the UE receives a control message from the macro cell to report measurements associated with the pico cell. For example, as illustrated in FIG. 2, the controlling module 204 receives the control message from the macro cell for reporting measurements associated with the pico cell 104.

In step 408, the UE removes the barred frequency from a barred list. For example, as illustrated in FIG. 2, the controlling module 204 removes the barred frequency f1 from the barred list, after the UE 110 received a control message from the macro cell 102 indicating that the UE 110 is to remove the barred frequency f1 from the barred list.

Some of the various actions, units, steps, blocks, or acts illustrated in FIG. 4 may be performed in the order presented, in a different order, simultaneously, or a combination thereof. Furthermore, in some embodiments, some of the actions, units, steps, blocks, or acts illustrated in FIG. 4 may be omitted.

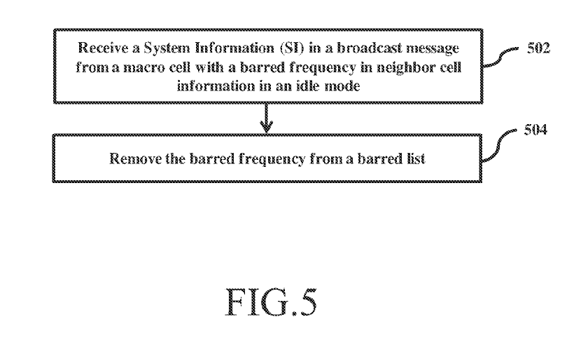

FIG. 5 is a flow diagram illustrating a method for removing a barred frequency in an idle mode, after barring a frequency of a pico cell, according to an embodiment as disclosed herein.

Referring to FIG. 5, when the UE 110 bars the primary frequency f1 of the pico cell 104, the UE 110 scans on the secondary frequency f2 of the macro cell. Further, the UE 110 acquires the SI from the macro cell 102 and camps on the macro cell 102 during the cell selection procedure in the idle mode.

When the UE 110 enters the pico cell area 106, in step 502, the UE 110 receives the SI in a broadcast message from the macro cell 102 with the barred frequency f1 in the neighbor cell information in the idle mode. Specifically, the controlling module 204 receives the SI in the broadcast message from the macro cell 102. The SI from the macro cell 102 includes the barred frequency f1 in the neighbor cell information.

In step 504, the UE 110 removing the barred frequency f1 from the barred list. Specifically, the controlling module 204 removes the barred frequency f1 from the barred list. Thereafter, the controlling module 204 scans the frequency f1 of the pico cell 104 and camps on the pico cell.

Some of the various actions, units, steps, blocks, or acts illustrated in FIG. 5 may be performed in the order presented, in a different order, simultaneously, or a combination thereof. Furthermore, in some embodiments, some of the actions, units, steps, blocks, or acts illustrated in FIG. 5 may be omitted.

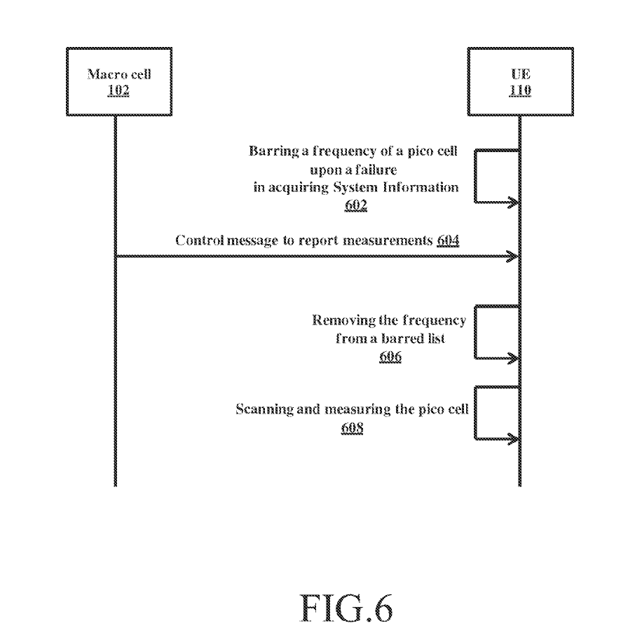

FIG. 6 is a sequence diagram illustrating various signaling flow messages between a macro cell and a UE in a CRE region for removing a barred frequency, according to an embodiment as disclosed herein.

Referring to FIG. 6, in step 602, the UE 110 bars a frequency f1 of the pico cell 104, when the UE 110 fails to acquire the SI from the pico cell 104. Further, the UE 110 scans a frequency f2 corresponding to the macro cell 102, acquires the SI from the macro cell 102, and camps on the macro cell 102.

When the UE 110 is camped on the macro cell 102, the macro cell 102 sends the control message to the UE 110 in step 604. The control message from the macro cell 102 requests the measurement report from the UE 110.

In step 606, the UE 110 receives the control message from the macro cell 102 and removes the barred frequency f1 from the barred list.

In step 608, the UE 110 the frequency f1 to camp on the pico cell 104 during the cell selection procedure.

Thereafter, the UE 110 measures the signal strength of the pico cell 104 and sends the measurement report to the macro cell 102, which determines whether to offload the UE 110 to the pico cell 104, based on the measurement report.

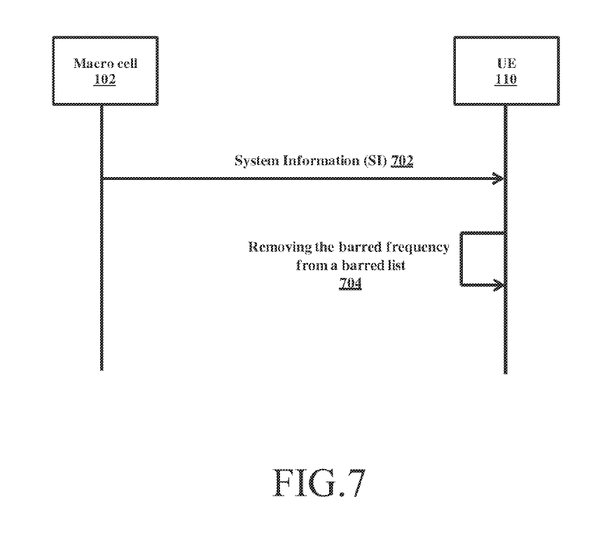

FIG. 7 is a sequence diagram illustrating various signaling messages between a macro cell and a UE in a CRE region for removing a barred frequency in an idle mode, according to an embodiment as disclosed herein.

Referring to FIG. 7, when the UE 110 in the CRE region is in the idle mode, the UE 110 bars a primary frequency f1 of the pico cell 104 and scans a secondary frequency f2 for camping on the macro cell 102. Specifically, the UE 110 camps on the macro cell 102 after acquiring the SI from the macro cell.

In step 702, the UE 110 receives the SI in the broadcast message. For example, the SI includes the barred frequency in the neighboring cell information.

In step 704, the UE 110 receives the SI from the macro cell 102 and removes the barred primary frequency f1 from the barred list. Thereafter, the UE 110 scans the primary frequency f1 of the pico cell 104 for cell selection in the CRE region.

The above-described embodiments disclosed herein can be implemented through at least one software program running on at least one hardware device and performing network management functions to control the elements. For example, the elements illustrated in FIGS. 2, 6, and 7 include blocks which can be at least one of a hardware device, or a combination of hardware device and software module.

Although the above-described embodiments have been described with reference to specific examples, it may be evident that various modifications and changes may be made to these embodiments without departing from the broader spirit and scope of the various embodiments. Furthermore, the various devices, modules, etc., described herein may be enabled and operated using hardware circuitry, for example, complementary metal oxide semiconductor based logic circuitry, firmware, software and/or any combination of hardware, firmware, and/or software embodied in a machine readable medium.

While the present disclosure has been particularly shown and described with reference to certain embodiments thereof, it may be understood by those of ordinary skill in the art that various changes in form and details may be made therein without departing from the spirit and scope of the present disclosure as defined by the following claims and their equivalents.

What is claimed is:

1. A method of a User Equipment (UE) for cell selection in a Cell Range Extension (CRE) region of a heterogeneous network, the method comprising:
avoiding barring a primary frequency at a transition to an idle mode, after failing to acquire System Information (SI) from a pico cell in the heterogeneous network; and
camping on a cell corresponding to one of the primary frequency and a secondary frequency.

2. The method of claim 1, wherein the primary frequency and the secondary frequency are identical, when a macro cell and the pico cell use a same frequency.

3. The method of claim 1, wherein the primary frequency and the secondary frequency are different from each other, when a macro cell and the pico cell operate using different frequencies.

4. The method of claim 1, further comprising receiving, from the pico cell, a control message including an Information Element (IE) indicating that the UE is to avoid barring the primary frequency in the idle mode.

5. The method of claim 1, wherein camping on the cell comprises scanning the secondary frequency.

6. The method of claim 5, wherein camping on the cell further comprises receiving an SI from the cell.

7. The method of claim 1, further comprising receiving, from a macro cell, a measurement report request to measure the pico cell.

8. A method of a User Equipment (UE) for removing a barred frequency in a Cell Range Extension (CRE) region of a heterogeneous network, the method comprising:
barring a frequency at a transition to an idle mode, after failing to acquire System Information (SI) from a pico cell in the heterogeneous network;
receiving, from a macro cell, a control message that requests the UE to report measurements associated with the pico cell; and
removing the frequency from a barred list, in response to the control message.

9. The method of claim 8, wherein the control message indicates that UE is to remove the frequency from the barred list.

10. The method of claim 8, further comprising receiving, from the macro cell, a measurement report request to measure the pico cell.

11. A User Equipment (UE) for cell selection in a Cell Range Extension (CRE) region of a heterogeneous network, the UE comprising:
an integrated circuit including a processor; and
a memory that stores a computer program code,
wherein the computer program code, when executed by the processor, controls the UE to:
avoid barring a primary frequency at a transition to an idle mode, after failing to acquire System Information (SI) from a pico cell in the heterogeneous network; and
camp on a cell corresponding to one of the primary frequency and a secondary frequency.

12. The UE of claim 11, wherein the primary frequency and the secondary frequency are identical, when a macro cell and the pico cell operate using a same frequency.

13. The UE of claim 11, wherein the primary frequency and the secondary frequency are different from each other, when a macro cell and the pico cell are operating using different frequencies.

14. The UE of claim 11, wherein the computer program code, when executed by the processor, controls the UE to receive, from the pico cell, a control message including an Information Element (IE) that indicates that the UE is to avoid barring the primary frequency in the idle mode.

15. The UE of claim 11, wherein the computer program code, when executed by the processor, camps on the cell by scanning the secondary frequency.

16. The UE of claim 15, wherein the computer program code, when executed by the processor, camps on the cell by receiving an SI from the cell, after scanning.

17. The UE of claim 11, wherein the computer program code, when executed by the processor, controls the UE to:
bar a frequency at the transition to the idle mode, after failing to acquire the SI from the pico cell in the heterogeneous network;
receive, from a macro cell, a control message requesting the UE to report measurements associated with the pico cell; and
remove the frequency from a barred list.

18. The UE of claim 17, wherein the control message indicates that UE is to remove the frequency from the barred list.

19. The UE of claim 11, wherein the computer program code, when executed by the processor, controls the UE to:
receive the SI in a broadcast message from a macro cell with a barred frequency in neighbor cell information in the idle mode; and
remove the barred frequency from a barred list.

20. The UE of claim 11, wherein the computer program code, when executed by the processor, controls the UE to receive, from a macro cell, a measurement report request to measure the pico cell.
